(19) United States
(12) Patent Application Publication
(10) Pub. No.: US 2024/0311910 A1
(43) Pub. Date: Sep. 19, 2024

(54) SYSTEMS, METHODS, AND STORAGE MEDIA FOR QUASI-RANDOM DISTRIBUTION OF NON-FUNGIBLE TOKEN ASSETS

(71) Applicant: Bloom Protocol, LLC, Bronx, NY (US)

(72) Inventors: Dustin van Schouwen, Portsmouth, NH (US); Isaac Patka, Glenmont, NY (US)

(73) Assignee: Bloom Protocol, LLC, Bronx, NY (US)

(21) Appl. No.: 18/185,375

(22) Filed: Mar. 17, 2023

(51) Int. Cl. G06Q 40/04; G06F 16/18; G06Q 20/38

(52) U.S. Cl. CPC G06Q 40/04; G06F 16/1865; G06Q 20/389

(57) ABSTRACT

Systems, methods, and storage media for quasi-random distribution of non-fungible token assets are disclosed and may: generate, by a first user, at least one metadata file associated with a digital asset; upload, by the first user, the at least one metadata file associated with the digital asset; generate, by the first user, a non-fungible token based on the at least one metadata file; deposit, by the first user, the non-fungible token within an exchange system; generate, by the first user, at least one fungible token associated with the non-fungible token; exchange, by the first user, the at least one fungible token with a second user; redeem, by the second user, the at least one fungible token for the non-fungible token; transfer the non-fungible token to an address associated to the second user.

### CROSS-REFERENCE TO RELATED APPLICATIONS

The present application claims priority under 35 U.S.C. § 119(e) of U.S. Provisional Patent Application Ser. No. 63/269,539 filed on Mar. 17, 2022 and titled SYSTEMS AND METHODS FOR QUASI-RANDOM DISTRIBUTION OF NON-FUNGIBLE TOKEN ASSETS, the contents of which are incorporated herein by reference in their entirety.

### FIELD OF THE DISCLOSURE

The present disclosure relates to systems, methods, and storage media for quasi-random distribution of non-fungible token assets.

### BACKGROUND

With the development of the ERC721 token standard and the onset of non-fungible tokens (also known as NFTs), we have seen many systems, platforms, and methods of managing their creation, distribution and use. Many of these systems and platforms mirror those already in place for traditional cryptocurrency or fungible token use and distribution.

The increased popularity of non-fungible token(s) has expanded the need for additional methods of distribution whether through direct sale, auction, or marketed give-away opportunities. Current technologies lack the ability to allow for the use of traditional fungible tokens (such as cryptocurrencies like Ethereum and Bitcoin) in order to acquire non-fungible token(s) without utilizing additional “traditional” centralized technologies and platforms. Technologies currently lack the ability to split non-fungible tokens into fungible tokens for more effective distribution. Furthermore, many of these technologies lack the requisite levels of randomization and anonymization necessary to operate as well as traditional decentralized exchanges normally associated with fungible tokens.

This background information is provided to reveal information believed by the applicant to be of possible relevance to the present invention. No admission is necessarily intended, nor should be construed, that any of the preceding information constitutes prior art against the present invention.

### SUMMARY

One aspect of the present disclosure relates to a system. The system may include one or more hardware processors configured by machine-readable instructions. The processor(s) may be configured to generate, by a first user, at least one metadata file associated with a digital asset. The processor(s) may be configured to upload, by the first user, the at least one metadata file associated with the digital asset. The processor(s) may be configured to generate, by the first user, a non-fungible token based on the at least one metadata file. The processor(s) may be configured to deposit, by the first user, the non-fungible token within an exchange system. The processor(s) may be configured to generate, by the first user, at least one fungible token associated with the non-fungible token. The processor(s) may be configured to exchange, by the first user, the at least one fungible token with a second user. The processor(s) may be configured to redeem, by the second user, the at least one fungible token for the non-fungible token. The processor(s) may be configured to transfer the non-fungible token to an address associated to the second user. The processor(s) may be configured to upload, by the first user, the digital asset to the address associated with the transferred non-fungible token.

In some implementations of the system, the metadata file may further include address information associated with the digital asset.

In some implementations of the system, the address information may be associated with a decentralized file system.

In some implementations of the system, the address information may further include a checksum hash utilized to describe the digital asset.

In some implementations of the system, the checksum hash may be utilized by the first user in the generation of the at least one non-fungible token.

In some implementations of the system, the at least one fungible token may be associated with the at least one non-fungible token through at least one positive real number constant.

In some implementations of the system, the exchange of the fungible token between the first and second user may occur through a quasi-random function.

In some implementations of the system, the method may further include the step of announcing the upload of digital asset to the address associated with the non-fungible token.

Another aspect of the present disclosure relates to a method. The method may include generating, by a first user, at least one metadata file associated with a digital asset. The method may include uploading, by the first user, the at least one metadata file associated with the digital asset. The method may include generating, by the first user, a non-fungible token based on the at least one metadata file. The method may include depositing, by the first user, the non-fungible token within an exchange system. The method may include generating, by the first user, at least one fungible token associated with the non-fungible token. The method may include exchanging, by the first user, the at least one fungible token with a second user. The method may include redeeming, by the second user, the at least one fungible token for the non-fungible token. The method may include transferring the non-fungible token to an address associated to the second user. The method may include uploading, by the first user, the digital asset to the address associated with the transferred non-fungible token.

Yet another aspect of the present disclosure relates to a non-transient computer-readable storage medium having instructions embodied thereon, the instructions being executable by one or more processors to perform a method. The method may include generating, by a first user, at least one metadata file associated with a digital asset. The method may include uploading, by the first user, the at least one metadata file associated with the digital asset. The method may include generating, by the first user, a non-fungible token based on the at least one metadata file. The method may include depositing, by the first user, the non-fungible token within an exchange system. The method may include generating, by the first user, at least one fungible token associated with the non-fungible token. The method may include exchanging, by the first user, the at least one fungible token with a second user. The method may include redeeming, by the second user, the at least one fungible token for the non-fungible token. The method may include transferring the non-fungible token to an address associated to the second user. The method may include uploading, by the first user, the digital asset to the address associated with the transferred non-fungible token.

These and other features, and characteristics of the present technology, as well as the methods of operation and functions of the related elements of structure and the combination of parts and economies of manufacture, will become more apparent upon consideration of the following description and the appended Claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the Claims, the singular form of ‘a’, ‘an’, and ‘the’ include plural referents unless the context clearly dictates otherwise.

### BRIEF DESCRIPTION OF THE DRAWINGS

FIG. 1 illustrates a system 100 configured for quasi-random distribution of non-fungible token assets, in accordance with one or more implementations.

FIG. 2 illustrates an exemplary diagram of a decentralized ledger network 200 found within the system 100, in accordance with one or more implementations.

FIG. 3 illustrates an exemplary data flow diagram of the protocol 300 tied to the system 100, in accordance with one or more implementations.

FIG. 4 illustrates a method 400 for quasi-random distribution of non-fungible token assets, in accordance with one or more implementations.

### DETAILED DESCRIPTION

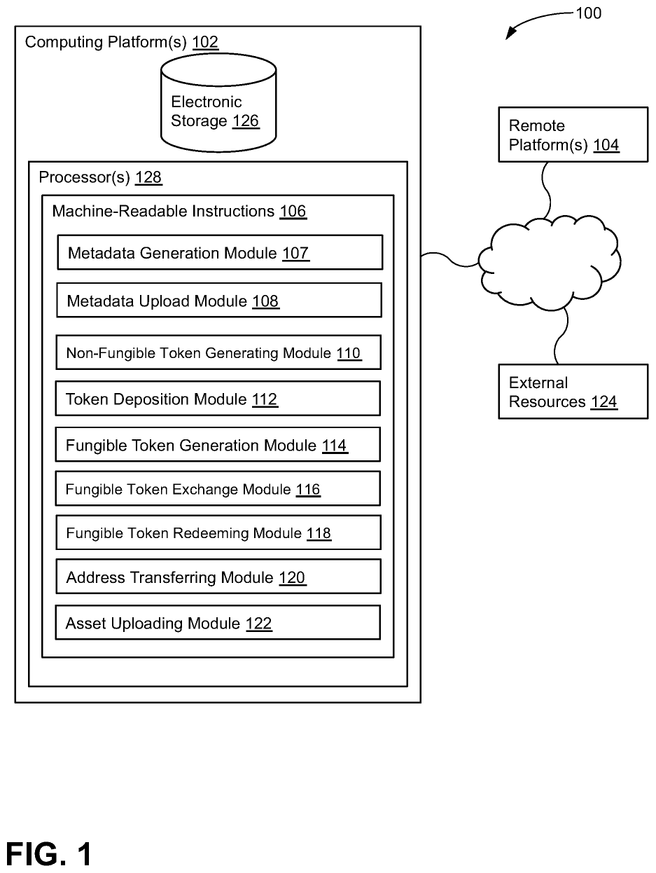

FIG. 1 illustrates a system 100 configured for non-fungible token assets, in accordance with one or more implementations. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction modules. The instruction modules may include computer program modules. The instruction modules may include one or more of metadata upload module 108, non-fungible token generating module 110, token deposition module 112, fungible token generation module 114, fungible token exchange module 116, fungible token redeeming module 118, address transferring module 120, asset uploading module 122, and/or other instruction modules.

Metadata generation module 107 may be configured to generate the metadata from the digital asset held by the content holder(s) 302/first user. The metadata files are generated using generic JavaScript object notation (JSON) based on a checksum/hash of the digital asset. The metadata may include the name and description of the digital asset along with information of the exchange system 310 (discussed below). The metadata file may further include address information associated with the digital asset. The address information may be associated with a decentralized file system 304. The address information may further include a checksum hash utilized to describe the digital asset. The checksum hash may be utilized by the first user in the generation of the at least one non-fungible token. A content identifier identifying the digital asset is generated for the decentralized file system 304. This content identifier is based on a checksum or hash of the contents of the digital asset.

Metadata upload module 108 may be configured to upload, by a first user (known also as a content holder(s) 302), at least one metadata file associated with a digital asset. A digital asset may be any type of digital file that the content holder(s) 302 wishes to distribute through the system 100. This can include audio, visual, or any other type of data type normally distributed through an associated non-fungible token but is not limited and may include any data type that a content holder(s) wishes to distribute through the system 100. As further discussed within operation 320 below, the first user/content holder(s) 302 may transfer the generated metafile into the decentralized file system 304 (discussed below) by way of any number of file transfer method(s) including protocols built into the decentralized file system 304, direct transfer into a decentralized ledger system connected as an external resource 124, or common internet transfer protocols (HTTP, FTP, SMTP, IMAP, OAuth, email generally, etc.). The metadata file may further include address information associated with the digital asset. The address information may be associated with a decentralized file system. The address information may further include a checksum hash utilized to describe the digital asset. The checksum hash may be utilized by the first user in the generation of the at least one non-fungible token. A content identifier identifying the digital asset is generated for the decentralized file system 304. This content identifier is based on a checksum or hash of the contents of the digital asset. The metadata files are generated using generic JSON based on the checksum/hash of the digital asset. The metadata may include the name and description of the digital asset along with information of the exchange system 310 (discussed below).

Non-fungible token generating module 110 may be configured to generate, by the first user, a non-fungible token based on the at least one metadata file. This module may work in conjunction with the non-fungible token(s) smart contract 308. The key between fungible and non-fungible tokens is their association to a digital asset (the non-fungible tokens having a finite percentage association to the digital asset). Non-fungible token(s) as used within the system 100 may be based on the ERC721 standard (as described in relation to the Ethereum blockchain at https://ethereum.org/en/developers/docs/standards/tokens/erc-721/), but any other suitable standard for the generation of non-fungible tokens may be used as well. Fungible tokens may be based on the ERC20 standard (as described in relation to the Ethereum blockchain at https://ethereum.org/en/developers/docs/standards/tokens/erc-20/#top), but any other suitable standard for the generation of fungible tokens that is compatible with the corresponding non-fungible tokens within the system 100 may be used as well. A dual-purpose token may also replace or integrate with both fungible and non-fungible tokens within the system 100 (an example being the ERC1155 standard within the Ethereum blockchain as described in https://ethereum.org/en/developers/docs/standards/tokens/erc-1155/). The metadata address discussed above is stripped of ancillary address information associated with the decentralized file system in order to limit the information within the non-fungible token.

In some embodiments a content identifier (or CID) is generated from the metadata address information. This CID can be directly generated from applying a hashing function against the metadata JSON file located within the decentralized file system 304. Additional information such as a CID version identifier, digital file content type identifier, and identifiers for the checksum and hash algorithms used may be based on, but not limited to, CID specifications as found in the following sources: https://docs.ipfs.io/concepts/content-addressing/#identifier-formats; https://github.com/multiformats/cid/blob/ef1b2002394b15b1e6c26c30545fd485f2c4c138/README .md #decoding-algorithm; https://github.com/multiformats/cid. For added obfuscation, the SHA256 checksum of the CID for the metadata JSON file itself may also be used, which would require the content holder(s) 302/first user to have knowledge of the contents of the metadata JSON for the contents of the non-fungible token to be meaningful.

Token deposition module 112 may be configured to deposit, by the first user, the non-fungible token within an exchange system 310.

Fungible token generation module 114 may be configured to generate, by the content holder(s) 302/first user, at least one fungible token associated with the non-fungible token minted through non-fungible token generating module 110. The at least one fungible token may be associated with the at least one non-fungible token through at least one positive real number constant. This “real number constant” relates to an exchange rate between the fungible and non-fungible tokens that is established in order to affect the exchange and thus distribution of the non-fungible token(s) to at least one other second user/exchange participant(s) 312. This occurs upon creation of the exchange system 310 or at some time prior to the initiation of the exchange activity.

Fungible token exchange module 116 may be configured to exchange, by the first user, the at least one fungible token with a second user. As discussed throughout the specification, a second user may be one or more of the exchange system participants 312 and may also be content holder(s) 302 as well. This is discussed further in the discussion of protocol 300 below.

Fungible token redeeming module 118 may be configured to redeem, by the second user, the at least one fungible token for the non-fungible token.

Address transferring module 120 may be configured to transfer the non-fungible token to an address associated to the second user. The method may further include the step of announcing the upload of digital asset to the address associated with the non-fungible token.

Asset uploading module 122 may be configured to upload, by the first user, the digital asset to the address associated with the transferred non-fungible token.

In some implementations, the exchange of the fungible token between the first and second user may occur through a quasi-random function. Examples of quasi-random functions may include, but are not limited to, utilizing a timestamp to simulate randomness, using external smart contracts to generate randomness, utilizing oracle services to obtain a true random number.

In some implementations, computing platform(s) 102, remote platform(s) 104, and/or external resources 124 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 124 may be operatively linked via some other communication media or medium.

A given remote platform 104 may include one or more processors configured to execute computer program modules. The computer program modules may be configured to enable any user(s) associated with the given remote platform 104 to interface with system 100 and/or external resources 124, and/or provide other functionality attributed herein to remote platform(s) 104. By way of non-limiting example, a given remote platform 104 and/or a given computing platform 102 may include one or more of a server, a desktop computer, a laptop computer, a handheld computer, a tablet computing platform, a NetBook, a Smartphone, a gaming console, and/or other computing platforms.

External resources 124 may include sources of information outside of system 100, external entities participating with system 100, and/or other resources. In some implementations, some or all the functionality attributed herein to external resources 124 may be provided by resources included in system 100.

Computing platform(s) 102 may include electronic storage 126, one or more processors 128, and/or other components. Computing platform(s) 102 may include communication lines or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 126 may comprise non-transitory storage media that electronically stores information. The electronic storage media of electronic storage 126 may include one or both of system storage that is provided integrally (i.e., substantially non-removable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 126 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 126 may include one or more virtual storage resources (e.g., cloud storage, a virtual private network, and/or other virtual storage resources). Electronic storage 126 may store software algorithms, information determined by processor(s) 128, information received from computing platform(s) 102, information received from remote platform(s) 104, and/or other information that enables computing platform(s) 102 to function as described herein.

Processor(s) 128 may be configured to provide information processing capabilities in computing platform(s) 102. As such, processor(s) 128 may include one or more of a digital processor, an analog processor, a digital circuit designed to process information, an analog circuit designed to process information, a state machine, and/or other mechanisms for electronically processing information. Although processor(s) 128 is shown in FIG. 1 as a single entity, this is for illustrative purposes only. In some implementations, processor(s) 128 may include a plurality of processing units. These processing units may be physically located within the same device, or processor(s) 128 may represent processing functionality of a plurality of devices operating in coordination. Processor(s) 128 may be configured to execute modules 107, 108, 110, 112, 114, 116, 118, 120, and/or 122, and/or other modules. Processor(s) 128 may be configured to execute modules 107, 108, 110, 112, 114, 116, 118, 120, and/or 122, and/or other modules by software; hardware; firmware; some combination of software, hardware, and/or firmware; and/or other mechanisms for configuring processing capabilities on processor(s) 128. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 107, 108, 110, 112, 114, 116, 118, 120, and/or 122 are illustrated in FIG. 1 as being implemented within a single processing unit, in implementations in which processor(s) 128 includes multiple processing units, one or more of modules 107, 108, 110, 112, 114, 116, 118, 120, and/or 122 may be implemented remotely from the other modules. The description of the functionality provided by the different modules 107, 108, 110, 112, 114, 116, 118, 120, and/or 122 described below is for illustrative purposes, and is not intended to be limiting, as any of modules 107, 108, 110, 112, 114, 116, 118, 120, and/or 122 may provide functionality than is described. For example, one or more of modules 108, 110, 112, 114, 116, 118, 120, and/or 122 may be eliminated, and some or all its functionality may be provided by other ones of modules 107, 108, 110, 112, 114, 116, 118, 120, and/or 122. As another example, processor(s) 128 may be configured to execute one or more additional modules that may perform some or all the functionality attributed below to one of modules 107, 108, 110, 112, 114, 116, 118, 120, and/or 122.

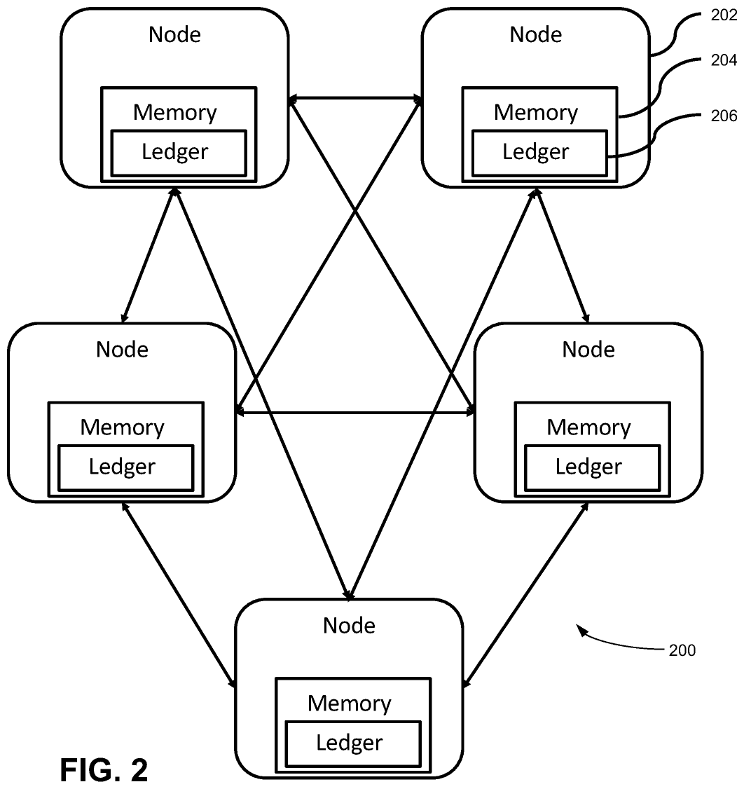

FIG. 2 illustrates an exemplary diagram of a remote platform(s) 104 as a decentralized ledger network found within the system 100, in accordance with one or more implementations. The remote platform(s) 104 may include a plurality of nodes 202, each node 202 in communication with at least one other node 202 within the network. Node(s) 202 may include computing platform(s) 102 but can also include any device capable of storing information and communicating over the remote platform(s) 104.

Each node 202 may further include a memory 204 that further stores all or a portion of a public ledger 206. The public ledger 206 may be utilized to store all or a portion of the machine-readable instructions 106 tied to the system 100. By way of example, the public ledger 206 may be used to store a blockchain smart contract utilized within system 100 and method 300. The memory may consist of electronic storage 126 and may comprise non-transitory storage media that electronically stores information as discussed within this disclosure. By way of example, the remote platform(s) 104 may be a network tied to any public or private blockchain network or networks in connection with any of a plurality of cryptocurrencies described within this disclosure.

The remote platform(s) 104 may include multiple instances of a decentralized ledger network in order to account for the interaction between users and exchanges.

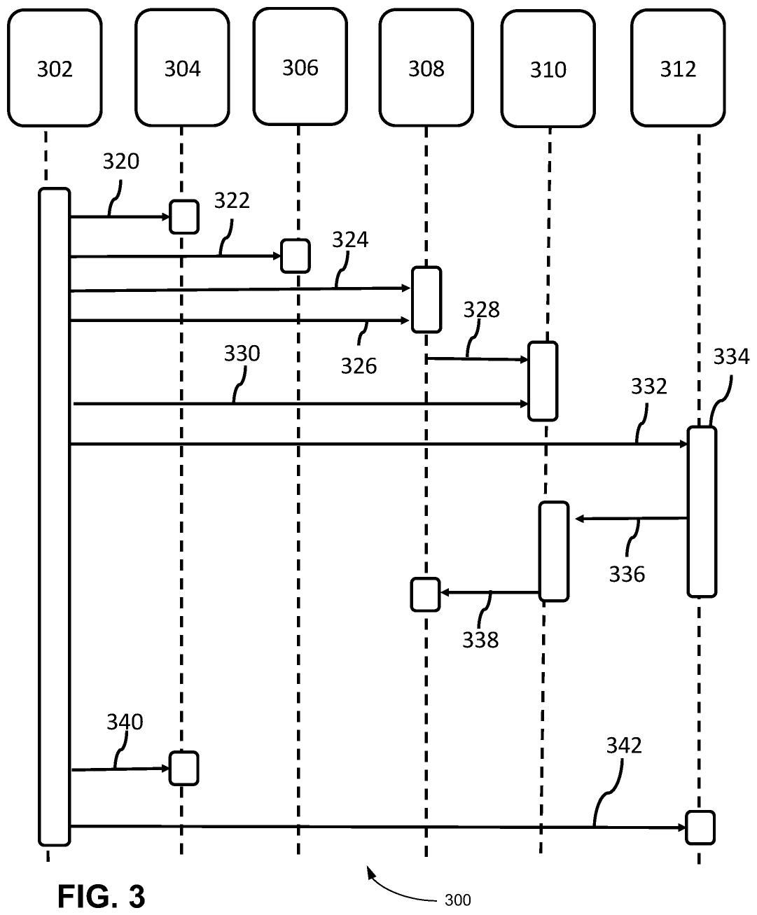

FIG. 3 illustrates an exemplary data flow diagram of the protocol 300 verification of information completeness system 100, in accordance with one or more implementations.

The protocol 300 may include any of the parties and/or elements that operate within the system 100. These parties and elements include content holder(s) 302, the decentralized file system 304, the fungible token(s) decentralized ledger 306, the non-fungible token(s) smart contract 308, the exchange system 310, and the exchange participant(s) 312. Both the content holder(s) 302 and the exchange participant(s) 312 may communicate directly or indirectly with any of the functional elements including the decentralized file system 304, the fungible token(s) decentralized ledger 306, the non-fungible token(s) smart contract 308, the exchange system 310, and may include any machine-readable instruction 106 that allows for the operation of functions on the remote platform(s) 104 and retained, either in whole or in part, within the ledger 206 of any memory 204. Any one of the parties may operate through a computing platform(s) 102 or any other resource in communication with the remote platform(s) 104.

A content holder(s) 302 is also known as the ‘first user’ throughout this specification and may be any party that wishes to randomly distribute a digital asset by way of the system 100. This can include unique user(s) with digital assets for distribution or other system(s) that may possess one or more digital assets and are programmatically setup to distribute digital assets through the system 100.

A decentralized file system 304 may include any file storage system that will allow for the storage of address location information for the digital assets distributed within the system 100. This decentralized file system 304 may incorporate a fully public and decentralized system such as IPFS or ZeroNet but may also include: any of the decentralized ledger networks discussed within this specification, private file sharing systems (including commercial cloud sharing services such as Box/Drop Box/etc.), as well as any standard internet address protocol (HTTP, FTP, SMTP, IMAP, OAuth, email generally, etc.) may be used.

A fungible token(s) decentralized ledger 306 may include any standard decentralized ledger system that would allow for the exchange of fungible tokens. This may be the Ethereum blockchain or any similar ledger system that is based on fungible token assets.

The non-fungible token(s) smart contract 308 is configured to allow the content holder(s) 302 to mint the necessary non-fungible token(s) associated with the digital asset to be distributed. The non-fungible token(s) smart contract 308 may include one or more of the modules within the system 100 as they are required to mint the non-fungible token(s) associated with the digital asset(s). The level of interaction between the non-fungible token(s) smart contract 308 and the system 100 will depend on the type of digital asset and the minted non-fungible token(s) themselves.

The exchange system 310 allows for the exchange of non-fungible and fungible tokens between content holder(s) 302 and exchange participants 312. Exchange participants 312 are also known as ‘second users’ within this specification and are either unique user(s) or other systems that may be programmatically setup to participate in the exchange of fungible tokens for non-fungible tokens and participate in the randomized distribution of digital asset(s). Other embodiments of the system 100 may allow for content holder(s) to also act as exchange participant(s) 312 and vice versa. A content holder(s) 302 can establish an instance of an exchange system 310 through a known decentralized ledger system (such as Ethereum), utilizing a preexisting platform (such as NFTX), or setting up a particular exchange system utilizing customized decentralized ledger code (such as through Hyperledger fabric or similar ledger architecture solutions). The key component of the exchange system is that it allows for the exchange of fungible, non-fungible, and/or dual functionality type tokens.

Alternate embodiments of the system 100 and protocol 300 may allow for the content holder(s) 302, the decentralized file system 304, the fungible token(s) decentralized ledger 306, the non-fungible token(s) smart contract 308, the exchange system 310, and the exchange participant(s) 312 roles and components to be performed by the same parties in multiple combination(s), or instances of parties and element(s) as based on the nature of the information. The term party/parties/system (s) may constitute human-directed or automated computing platform(s) 102, remote platform(s) 104, external resources 124, or other system(s) depending on the implementation.

The following operations give an exemplary representation of the data flow of protocol 300 through the verification of information completeness system 100 as explained in this disclosure.

Initially, at operation 320, a content holder(s) 302 uploads metadata files associated with the digital assets to the decentralized file system 304 using the metadata upload module 108. Once uploaded, the metadata file is now within an addressed location of the decentralized file system 304 that will be referenced within the generated non-fungible tokens (discussed below). It should be noted that only the generated metafile, and not the digital file itself, is uploaded to the decentralized filed system 304. The digital file may remain within a location accessible only to the content holder(s) 302 at this point.

At operation 322 the content holder(s) 302 may optionally deploy their own instance of the exchange system 310 in order to perform the distribution between the content holder(s) 302 and the exchange participants 312. As discussed above, this can be done instead of utilizing a previously established exchange system.

At operation 324, the content holder(s) 302 mints non-fungible tokens based on the address of the metadata file within the decentralized file system 304 through the non-fungible token(s) smart contract 308 along with non-fungible token generating module 110. Within some embodiments of the system 100, the non-fungible token generating module 110 is fully integrated into the non-fungible token(s) smart contract 308, but can exist separately as well.

At operation 326 the content holder(s) 302 directs non-fungible tokens to be deposited to the exchange system 310 by way of the fungible token deposition module 112. As per step 322, the exchange system can be preexisting or established by the content holder(s) 302 in order to allow for the exchange between the fungible and non-fungible tokens. This operation can be directed by the content holder(s) 302 directly or can be setup to operate automatically upon the completion of operation 324.

At operation 328 the non-fungible tokens are transferred from the non-fungible smart contract 308 to the exchange system 310 by way of the fungible token deposition module 112. Once transferred, the non-fungible token(s) allow the content holder(s) 302 to exchange the non-fungible tokens for fungible tokens found within the exchange system 310.

At operation 330 the content holder(s) 302 mints or transfers fungible tokens into the exchange system 310. This allows for the content holder(s) 302 to describe the value of the digital assets as a quantity of the fungible tokens that are minted. These digital assets are controlled by the exchange system 310 such that the fungible tokens can be redeemed by the exchange participant(s) 312 once the digital assets become available within the system 100 (such as during later operations).

At operation 332 the content holder(s) 302 engages in sale or exchange activities with other exchange participant(s) 312 utilizing the newly transferred fungible tokens by way of the fungible token exchange module 116. This conversion of a set of non-fungible tokens, of integer size n, will become the backing asset of a set of fungible tokens of equal or proportional size m, where a positive real number constant “o” exists such that n*o=m, provides facilities such that an amount o of the non-fungible token(s) can be interchangeable with one or more non-fungible token(s). This allows that at any time non-fungible tokens may be added to the exchange system 310 with or without limitation on the adding of new non-fungible tokens after some date. This also allows that with or without restriction on the permission(s) granted to different persons/organizations operating on the general decentralized ledger utilized as the basis for fungible tokens (such as the given public/private secp256k1/ECDSA keypairs used on Ethereum) or restriction on the rules governing who, how, or when tokens may be exchanged. A simple, stable, de-facto o-to-1 conversion rate is provided here for simplicity, but any arbitrary redemption/conversion logic for this conversion between the fungible and non-fungible tokens may be applied.

At operation 334 the exchange participant(s) 312 may engage in trading of fungible tokens within the exchange system 310. It should be noted that the exchange participant(s) 312 at this point may be indistinguishable from the original content holder(s) 302 and dependent on the embodiment of the system 100 there may be situation in which content holder(s) actively exchange non-fungible tokens to gather other non-fungible token(s) from other exchange participant(s) 312 that are content holder(s) 302 as well. “True randomness” is not achievable on most decentralized ledgers due to the necessarily deterministic nature of smart contracts, but it is possible for quasi-random functions to be employed for the order of token issuance to be further randomized, although this is of questionable use considering that withholding the original digital asset file from the decentralized file system 304 prevents meaningful interpretation of the hashes contained in the non-fungible tokens.

At operation 336 the exchange participant(s) 312 then redeem some number of fungible tokens for non-fungible tokens within the exchange system 310.

At operation 338 the exchange system 310 transfers the non-fungible token(s) to a specific exchange participant(s) 312 address. This address is associated to the exchange participant(s) 312 through the non-fungible token smart contract 308.

At operation 340 the content holder(s) 302 uploads some amount of the digital asset to the decentralized file system 304. At this point is when the exchange participant(s) 312 possess the digital asset in proportion to the non-fungible token(s) that they exchanged for within the exchange system 310.

At operation 342 the content holder(s) announces the uploading of the digital asset to the decentralized file system 304. This announcement can take the form of the revealing the digital asset completely to the public or announcing access to the exchange participant(s) 312 individually in addition to the granting of rights over the digital asset.

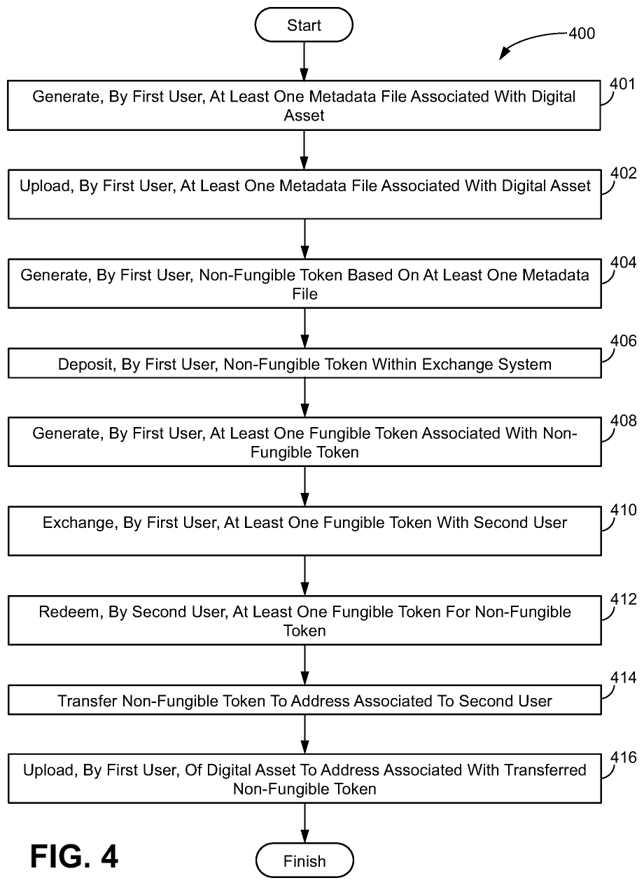

FIG. 4 illustrates a method 400 for quasi-random distribution of non-fungible token assets, in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all the operations of method 400 in response to instructions stored electronically on an electronic storage medium. The one or more processing devices may include one or more devices configured through hardware, firmware, and/or software to be specifically designed for execution of one or more of the operations of method 400.

An operation 401 may include generating, by a first user, at least one metadata file based on a digital asset. Operation 402 may be performed by one or more hardware processors configured by machine-readable instructions including a module that is the same as or like metadata generation module 107, in accordance with one or more implementations.

An operation 402 may include uploading, by a first user, at least one metadata file associated with a digital asset. Operation 402 may be performed by one or more hardware processors configured by machine-readable instructions including a module that is the same as or like metadata upload module 108, in accordance with one or more implementations.

An operation 404 may include generating, by the first user, a non-fungible token based on the at least one metadata file. Operation 404 may be performed by one or more hardware processors configured by machine-readable instructions including a module that is the same as or like non-fungible token generating module 110, in accordance with one or more implementations.

An operation 406 may include depositing, by the first user, the non-fungible token within an exchange system. Operation 406 may be performed by one or more hardware processors configured by machine-readable instructions including a module that is the same as or like token deposition module 112, in accordance with one or more implementations.

An operation 408 may include generating, by the first user, at least one fungible token associated with the non-fungible token. Operation 408 may be performed by one or more hardware processors configured by machine-readable instructions including a module that is the same as or like fungible token generation module 114, in accordance with one or more implementations.

An operation 410 may include exchanging, by the first user, the at least one fungible token with a second user. Operation 410 may be performed by one or more hardware processors configured by machine-readable instructions including a module that is the same as or like fungible token exchange module 116, in accordance with one or more implementations.

An operation 412 may include redeeming, by the second user, the at least one fungible token for the non-fungible token. Operation 412 may be performed by one or more hardware processors configured by machine-readable instructions including a module that is the same as or like fungible token redeeming module 118, in accordance with one or more implementations.

An operation 414 may include transferring the non-fungible token to an address associated to the second user. Operation 414 may be performed by one or more hardware processors configured by machine-readable instructions including a module that is the same as or like address transferring module 120, in accordance with one or more implementations.

An operation 416 may include uploading, by the first user, the digital asset to the address associated with the transferred non-fungible token. Operation 416 may be performed by one or more hardware processors configured by machine-readable instructions including a module that is the same as or like asset uploading module 122, in accordance with one or more implementations.

As will be appreciated by one skilled in the art, aspects of the present invention may be embodied as a system, method, or computer program(s). Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program(s) embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium or data store may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: portable computer diskette, hard disk, read only memory (ROM), optically readable storage media (e.g., CD-ROM, DVD), magnetically readable storage media (e.g., magnetic tape, magnetic hard drive, floppy drive), electrical charge-based storage media or random access memory (e.g., EEPROM, RAM), solid-state storage media (e.g., flash drive, solid-state hard drive), other electronically readable storage media and/or any suitable combination of the foregoing. In the context of this disclosure, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, Bluetooth, and/or any suitable combination of the foregoing.

Computer program code for carrying out operations for aspects of the present invention may be written in any combination of one or more programming languages, including: object oriented programming languages such as Java, Smalltalk, C++, conventional procedural programming languages such as the “C” programming language or similar programming languages, scripting language such as Perl, JavaScript/Typescript, and/or VBS, functional languages such as Lisp and/or ML, logic-oriented languages such as Prolog, and/or blockchain smart contract languages such as Solidity, Move, Tezos, fi, and/or Plutus. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a virtual private network (VPN), and/or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program(s) according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus or device provide processes for implementing the functions/acts specified in the flowchart and/or block diagram block or blocks.

The flowchart and block diagrams in the figures illustrate the architecture, functionality, and operation of possible implementations of the system(s), method(s), and computer program(s) according to various embodiments of the present invention. In this regard, each block in the flowchart or block diagrams may represent a module, segment, or portion of code, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program(s) may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instruction embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively or may include one or more stand-alone components. The hardware and software components of the computer system of the present disclosure may include and may be included within fixed and portable devices such as mobile devices, desktops, laptops, and/or servers. A module may be a component of a device, software, program, or system that implements some “functionality,” which can be embodied as software, hardware, firmware, and/or electronic circuitry.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended Claims. For example, it is to be understood that the present technology contemplates that, to the extent possible, one or more features of any implementation can be combined with one or more features of any other implementation.

What is claimed is:

1. A system, the system comprising:
one or more hardware processors configured by machine-readable instructions to:
generate, by a first user, at least one metadata file associated with a digital asset;
upload, by the first user, the at least one metadata file associated with the digital asset;
generate, by the first user, a non-fungible token based on the at least one metadata file;
deposit, by the first user, the non-fungible token within an exchange system;
generate, by the first user, at least one fungible token associated with the non-fungible token;
exchange, by the first user, the at least one fungible token with a second user;
redeem, by the second user, the at least one fungible token for the non-fungible token;
transfer the non-fungible token to an address associated to the second user.

2. The system of claim 1, wherein the metadata file further includes address information associated with the digital asset.

3. The system of claim 2, wherein the address information is associated with a decentralized file system.

4. The system of claim 2, wherein the address information further includes a checksum hash utilized to describe the digital asset.

5. The system of claim 3, wherein the checksum hash is utilized by the first user in the generation of the at least one non-fungible token.

6. The system of claim 1, wherein the at least one fungible token is associated with the at least one non-fungible token through at least one positive real number constant.

7. The system of claim 1, wherein the exchange of the fungible token between the first and second user occurs through a Quasi-random function.

8. The system of claim 1, the one or more hardware processors configured by machine-readable instructions to further include the step of announcing the upload of digital asset to the address associated with the non-fungible token.

9. The system of claim 1, the one or more hardware processors configured by machine-readable instructions to further include the step of uploading, by the first user, the digital asset to the address within the decentralized file system associated with the transferred non-fungible token.

10. A method, the method comprising:
generating, by a first user, at least one metadata file associated with a digital asset;
uploading, by the first user, at least one metadata file associated with the digital asset;
generating, by the first user, a non-fungible token based on the at least one metadata file;
depositing, by the first user, the non-fungible token within an exchange system;
generating, by the first user, at least one fungible token associated with the non-fungible token;
exchanging, by the first user, the at least one fungible token with a second user;
redeeming, by the second user, the at least one fungible token for the non-fungible token;
transferring the non-fungible token to an address associated to the second user.

11. The method of claim 10, wherein the metadata file further includes address information associated with the digital asset.

12. The method of claim 11, wherein the address information is associated with a decentralized file system.

13. The method of claim 11, wherein the address information further includes a checksum hash utilized to describe the digital asset.

14. The method of claim 12, wherein the checksum hash is utilized by the first user in the generation of the at least one non-fungible token.

15. The method of claim 10, wherein the at least one fungible token is associated with the at least one non-fungible token through at least one positive real number constant.

16. The method of claim 10, wherein the exchange of the fungible token between the first and second user occurs through a Quasi-random function.

17. The method of claim 10, the method further including the step of announcing the upload of digital asset to the address associated with the non-fungible token.

18. The method of claim 10, the method further including the step of uploading, by the first user, the digital asset to the address within the decentralized file system associated with the transferred non-fungible token.

19. A non-transient computer-readable storage medium having instructions embodied thereon, the instructions being executable by one or more processors to perform a method, the method comprising:
generating, by a first user, at least one metadata file associated with a digital asset;
uploading, by the first user, the at least one metadata file associated with the digital asset;
generating, by the first user, a non-fungible token based on the at least one metadata file;
depositing, by the first user, the non-fungible token within an exchange system;
generating, by the first user, at least one fungible token associated with the non-fungible token;
exchanging, by the first user, the at least one fungible token with a second user;
redeeming, by the second user, the at least one fungible token for the non-fungible token;
transferring the non-fungible token to an address associated to the second user.
